(19) United States
(12) Patent Application Publication
(10) Pub. No.: US 2002/0127974 A1
(43) Pub. Date: Sep. 12, 2002

(54) Shielded speaker for wireless telephones

(76) Inventor: Chang June Song, Richmond (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/802,422

(22) Filed: Mar. 9, 2001

(51) Int. Cl. H04B 1/38

(52) U.S. Cl. 455/90; 455/575

(57) ABSTRACT

A speaker for a wireless phone is enclosed in an electrically conductive housing the to suppress electromagnetic energy that may emanate from the speaker.

### CROSS-REFERENCES TO RELATED APPLICATIONS

This application claims priority to co-pending U.S. Provisional Patent Application 60/261,087, filed Jan. 11, 2001, the disclosure of which is incorporated herein in its entirety for all purposes.

### BACKGROUND OF THE INVENTION

The present invention relates to telecommunication equipment, and more particularly to a wireless telephone in which the speaker is housed within a conductive enclosure to reduce electromagnetic emission therefrom.

Wireless telephones, including cell phones, are a common commodity today. They provide instant communicative access to others, allowing one to be in touch with others almost whenever they want and wherever they are. Unfortunately, the convenience of wireless telephones may come at a price. There are increasing concerns about certain health hazards associated with wireless phone use. Even though the energy emanating from the phone (e.g., the antenna, speaker area, etc.) is relatively small, there is mounting evidence to support these concerns, suggesting that the close proximity of such sources of electromagnetic radiation (“EMR”) to a user's head can cause tumors to form on the brain, or cause other genetic damage. Nervousness about the harmful potential of microwaves, which at a distance are considered harmless, but when close the head, and particularly the ear and brain, are more worrisome, has caused the FCC to regulate the amount of energy that wireless phones are allowed to emit.

The industry continues to maintain that all cell phones sold in the United States meet government regulations and are safe, and recent studies tend to bear this out. However, critics claim that studies implying the safety of wireless phones are flawed, and many sources continue to be troubled about the energy emitted by wireless telephones. This continuing concern has prompted the Cellular Telecommunications Industry Associates (“CTIA”) to require those cell phone manufacturers who wish to be certified by CTIA to submit radiation data.

It is believed that one point of EMR in a wireless telephone is the speaker element. For example, referring to FIG. 1, there is shown a wireless telephone representation 1, which may be a conventional cell phone or a wireless phone for home use. As FIG. 1 illustrates, the wireless telephone 1 includes a case or shell 2 that contains the electronics 3, which would include the oscillator, receiver, and transmitter sections. Received signals at the antenna 4 are conveyed to the electronics 3, converted to electrical signals that are communicated to a speaker element 5, situated behind a speaker grill or earpiece 6, by electrical or speaker wiring 8 to use the diaphragm of the speaker to produce audio. It is believed that the RF energy emitted by the electronics 3 (e.g., the oscillator and transmitter sections) is picked up by the speaker wiring 8 and speaker 5 to be emitted to the user when the wireless telephone 1 is in use. The concern is that the close proximity of this source of EMR, i.e., the speaker 5, to the head, ear, ear canal, and brain of a user of the wireless telephone 1 is a significant hazard.

Thus, there appears a need for a wireless telephone construction that is less harmful to users than is available today.

### BRIEF SUMMARY OF THE INVENTION

The present invention provides a wireless telephone construction that has lower electromagnetic radiation than prior wireless phone constructions.

The present invention is generally directed to reducing electromagnetic radiation (EMR) emitted from wireless telephone construction by shielding the speaker assembly. Broadly, the present invention comprises a housing that is constructed of an electromagnetic conductive material to enclose the speaker assembly of a wireless telephone to contain EMR that may emanate from the speaker, thereby preventing those emissions from reaching a user of the wireless telephone.

Among the advantages achieved by the present invention is the reduction of EMR emissions from a wireless telephone is reduced by the present invention.

This, and other, advantages of the present invention will become apparent to those skilled in this art upon a reading of the following description of the embodiments of the invention, which should be taken in conjunction with accompanying drawings.

### BRIEF DESCRIPTION OF THE DRAWINGS

FIG. 1 is a representation of a conventional wireless telephone;

FIG. 2 is a side, sectional view of one embodiment of the invention;

FIG. 3 is an exploded view of the embodiment of the invention shown in FIG. 2;

FIG. 4 is a side, sectional view of another embodiment of the invention;

FIG. 5 is an exploded view of the embodiment of the invention shown in FIG. 4; and

FIG. 6 is an isometric view of the embodiment of the invention shown in FIGS. 4 and 5 in assembled form.

### DESCRIPTION OF EMBODIMENTS THE INVENTION

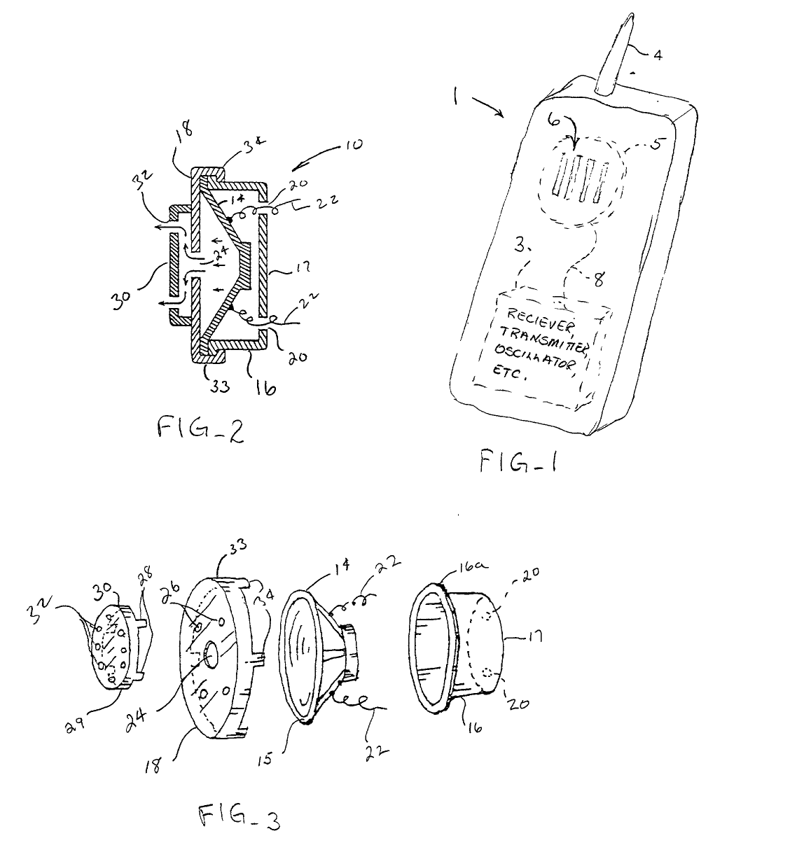

Referring now to the drawings, a first embodiment of a shielded speaker according to the present invention is illustrated in cross-section in FIG. 2 and in exploded view in FIG. 3. Designated with the reference numeral 10, the shielded speaker includes a conventional speaker assembly 14 housed in an enclosure formed by a rear cup 16 and front plate 18. Openings 20 are formed in a back wall 17 of the rear cup 16 to allow speaker-wiring 22 to be passed therethrough to the speaker assembly 14.

As better seen in FIG. 3, the front plate 18 is perforated to form an acoustic pathway 24. The acoustic pathway 24 allows egress of acoustic energy generated by the speaker assembly from the housing formed by connection of the rear cup 16 to the front plate 18 as shown in FIG. 2. Apertures 26 are formed in the front plate 18 to receive legs 28 formed on a circumferential ring 29 that extends from the periphery of a baffle 30. The legs 28 operate to attach the baffle 30 to the front plate 18. The baffle 30 is apertured to include acoustic pathways 32 for allowing the passage of audio produced by the speaker 14. Preferably, the acoustic pathway 24 formed in the front plate 18 and the acoustic pathways 32 formed in the baffle 30 are sized relative to the wavelength of the RF energy being suppressed to minimize escape of EMR. In addition, it is believed that for opetimal EMR shielding the total combined area of the acoustic pathways 32 be no greater, and preferrably approximately equal, to the area of the acoustic pathway 24.

The front plate 18 includes a circumferential ring 33 formed to extend from the periphery of the front plate 18. Extending form he margin of the circumferential ring 33 are tabs 34, which are used to attach the front plate 18 to the rear cup 16 by folding the tabs 34 around the flange 16a (see FIG. 3) formed on the periphery of the rear cup 16. A flange 15 is similarly formed on the speaker assembly 14, shaped and configured to be captured by, and held between, the flange 16a of the rear cup 16 and the front plate 18—as best seen in FIG. 2.

Preferably, the components used to form the housing that encloses the speaker 14, i.e. the rear cup 16, front plate 18, and baffle 30, are constructed of an electrically conductive material to provide EMR shielding. Alternatively, the components could be fabricated from a non-conductive material, such as plastic for some form of fiberboard, with an electrically conductive film covering one or both surfaces of each. The film could be a thin copper, aluminum, or even gold sheets. In addition, it is also preferable that the speaker wiring 22 also be shielded for additional EMR protection.

When constructed, as shown in FIG. 2, and as described above, the shielded speaker 10 replaces the speaker 5 of the wireless telephone 1 (FIG. 1) to operate generally as follows. The speaker wiring 22 extend through the apertures 20 formed in the rear cup 16 for that purpose and connect to the electronics 3 of the wireless telephone 1. The speaker wiring 22 will communicate electrical energy embodying sound to the speaker 14 in conventional fashion. The speaker 14, in turn, will convert the electrical energy to acoustic energy. Acoustic energy produced by the speaker assembly will pass through the acoustic pathways 24 of the front plate 18 and 32 of the baffle 30, through the speaker grill 6 (FIG. 1), and be passed to a user.

At the same time, the electrically conductive housing surrounding the speaker 14, formed by the rear cup 16 and front plate 18, will inhibit much, if not all, of any EMR energy that may be generated by the electronics 3 and transmitted to the speaker 14 for radiation therefrom. The baffle 30 operates to further inhibit any EMR that may escape the front plate 18.

Turning now to FIG. 4, there is illustrated alternate embodiment of the shielded speaker of the present invention. As FIG. 4 shows, the alternate embodiment of the shielded speaker, designated generally with the reference numeral 100, comprises a cup-like casing 105 that forms a recess 107 to receive a speaker holder 112 through an opening 109. A flange surrounds and extends outward from the opening 109.

The speaker holder 112 includes an annular sidewall 113 that, with a back wall 115, forms a recess in which is mounted a conventional speaker assembly 114. As best seen in FIG. 5, the speaker holder 112 has, extending from the margin 113a of the annular sidewall 113, connector tabs 116, the terminus of which each have small stubs 117 formed thereon. The stubs 117 are sized and configured to be snuggly received by openings 118 formed in the casing 105 of the shielded speaker 110 to hold the speaker holder 112 in the recess 107 of the casing 105.

Also extending from the margin 113a of the annular sidewall 113 are tabs 115 that are configured to fold around and capture a surrounding flange 114a formed on the speaker assembly 114 to hold the speaker assembly in the holder 112 as illustrated in FIG. 4. With the speaker assembly 114 mounted in the speaker holder 112, and the speaker holder, in turn, mounted in the casing 105, the diaphragm 114b of the faces toward the back wall 110 of the casing.

Finally, a baffle 130 attaches to an outer flange 111 formed on the casing 110 by tabs 132. Apertures 134 are formed in the baffle 130 to permit the emission of acoustic vibrations produced by the speaker 114. As best seen in FIG. 4 by the arrows, sound produced by the speaker 114 will first be directed toward the back 120 of the case 110, and then around the outside of the case 112 to be emitted from the apertures 134.

As with the embodiments of FIGS. 1 and 2, the elements, i.e., the back case 110, speaker holder 112, and baffle 130, are preferably formed of, or are coated with, an electrically transmissive material in order to provide EMR shielding to EMR emissions from the speaker 114. Also, it is advisable that the speaker wiring 22′ that connects the speaker assembly to the electronics 3 of the wireless telephone 1 (FIG. 1), when replacing the conventional speaker 5, be housed or enclosed in EMR shielding. Apertures 20′ are formed in the sidewalls 113 and 108 of the speaker holder 112 and casing 105 for passage of the speaker wiring.

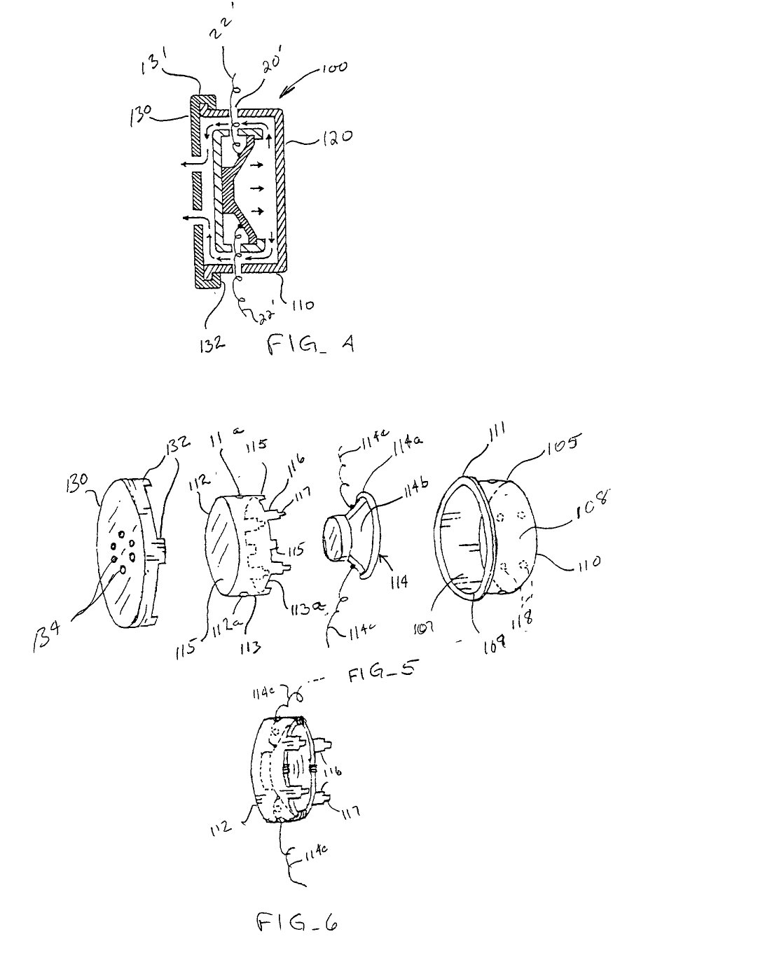

FIG. 6 illustrates the embodiment in assembled form, illustrating the enclosure of the speaker within the housing. The emanation of any EMR that may be transmitted to the speaker is believed reduced by the housing.

With the speaker assembly mounted in the housing formed by the casing 105 and speaker holder 112, as shown in FIG. 4, sound energy generated by the speaker assembly will propagate from the diaphragm 114b toward the back wall 110 of the casing. The sound energy will then be reflected around the speaker assembly and speaker holder, as illustrated by the arrows in FIG. 4, toward the front plate 130 and out the acoustic passages 134. As with the shielded speaker 10 of FIGS. 2 and 3, the shielded speaker 100 will be mounted in the wireless telephone 1 proximate the speaker grill 6 to allow the acoustic energy to pass to a user.

What is claimed is:

1. A shielded speaker for a wireless telephone, including:
a housing fabricated from an electrically conductive material for containing the speaker.

2. The shielded speaker of claim 1, wherein the electrically conductive material is metallic.

3. The shielded speaker of claim 1, wherein the electrically conductive material is copper.

4. The shielded speaker of claim 1, wherein the electrically conductive material is aluminum.

5. The shielded speaker of claim 1, wherein the housing includes a copper film forming the electrically conductive material.

6. A shielded speaker for use in a wireless telephone, comprising:
a speaker operating to convert electrical signals to acoustic energy;
a rear cup; and
a front plate structured to be attached to the rear cup to hold the speaker, the front plate having apertures formed therein for the passage of acoustic energy;
wherein the rear cup and front plate are each fabricated with an electrically conductive material to prevent passage of electromagnetic radiation to pass therethrough and together form a housing that contains the speaker.

7. The shielded speaker of claim 6, wherein the rear cup has formed therein a recess for receiving the speaker and a circumferential flange surrounding an entry to the recess.

8. The shielded speaker of claim 7, wherein the speaker has a speaker flange formed and adapted to be captured and held between the circumferential flange of the rear cup and the front plate.

9. The shielded speaker of claim 6, wherein the front plate is formed to have a acoustic passageway formed therein for passage of acoustic energy produced by the speaker, and including a baffled mounted to the front plate spaced from but in confronting relation to the acoustic passageway.
